(19) United States
(12) Patent Application Publication
(10) Pub. No.: US 2021/0295345 A1
(43) Pub. Date: Sep. 23, 2021

(54) SYSTEM AND METHOD TO PROVIDE WARRANTY FOR A UTILITY EQUIPMENT

(71) Applicant: Jinesh Nirad Varia, Bothell, WA (US)

(72) Inventor: Jinesh Nirad Varia, Bothell, WA (US)

(21) Appl. No.: 16/993,642

(22) Filed: Aug. 14, 2020

Related U.S. Application Data
(60) Provisional application No. 62/888,503, filed on Aug. 18, 2019.

(51) Int. Cl. G06Q 30/00; G06Q 30/02; G06Q 10/00; G06Q 10/08; G06Q 10/10; G06N 5/04

(52) U.S. Cl. CPC G06Q 30/012; G06Q 30/0185; G06Q 30/0201; G06Q 10/20; G06Q 30/0234; G06Q 30/0206; G06Q 10/10; G06N 5/04; G06Q 10/087

(57) ABSTRACT

A system to provide warranty for a utility equipment is disclosed. The system includes a component detection subsystem to detect at least one authenticated component for uniqueness and compliance by scanning a unique encrypted code, identifies usage of the at least one authenticated component. A usage data collection subsystem to collect usage and event data representative of usage of the at least one authenticated component. An asset score generation subsystem to create a weight profile associated with multiple maintenance and operational events and timing of the multiple events of the utility equipment, generates an asset score associated with utility equipment. An asset score prediction subsystem to predict a rate of variation of the asset score. A warranty adjustment subsystem to adjust a warranty period and one or more terms and conditions in a warranty document dynamically based on the rate of variation of the asset score.

This application claims priority from a provisional patent application filed in the US having Patent Application No. 62/888,503, filed on Aug. 18, 2019 and titled “DYNAMIC WARRANTY”.

### BACKGROUND

Embodiments of the present disclosure relate to a maintenance repair and operations and more particularly to a system and a method to provide warranty for a utility equipment.

Original equipment manufacturers (OEMs) and distributors offer standard fixed-term manufacturer's warranty for sales of one or more equipment. Such manufacturer's warranties typically last for a definite period of time. During the definite period of time, one or more customers typically purchases various authenticated components or parts directly from the manufacturers or authorized distributors. Generally, after an expiration of the warranty, several times, the one or more customers does not attempt to purchase the genuine components or service from the one or more manufacturers or the authorized distributors and use counterfeit parts or service in order to reduce their operational costs. As a result, the OEMs lose on after-market sales for remaining lifetime of the one or more equipment. In order to cope up with business of the OEMs and also to facilitate the one or more customers various systems are available in market which offers multiple types of warranty programs to generate after-sales revenue.

Conventionally, the system available for offering the warranty programs to the one or more customers includes extended warranty programs for the authenticated components of the one or more equipment to manage the after sales revenue of the OEMs. However, such a conventional system offers the extended warranty programs in exchange of money from the one or more customers. Also, such extended warranty programs are offered to the one or more customers during purchasing of the one or more equipment. Moreover, such a conventional system is unable to track usage of the authenticated components or recommended services which are purchased by the one or more customers for the one or more equipment. Furthermore, such a conventional system is unable to enforce usage of the authenticated components to the one or more customers due to lack of any incentive which thereby leads to damage and destruction of the one or more equipment. In addition, such conventional system lacks in monitoring of usage of the authenticated components.

Hence, there is a need for an improved system and a method to provide warranty for a utility equipment in order to address the aforementioned issues.

### BRIEF DESCRIPTION

In accordance with an embodiment of the present disclosure, a system to provide warranty for a utility equipment is disclosed. The system includes a component detection subsystem to detect at least one authenticated component or at least one authenticated service for uniqueness and compliance by scanning a unique encrypted code associated with the at least one authenticated component or the at least one authenticated service of the utility equipment using one or more detection means. The component detection subsystem also identifies usage and event data of the at least one authenticated component or the at least one authenticated service in the utility equipment based on detection of the at least one authenticated component or the at least one authenticated service. The system also includes a usage data collection subsystem to collect usage data representative of usage of the at least one authenticated component or the at least one authenticated service via one or more communication platforms for transmission and storage of the usage data to a cloud-based platform. The system also includes an asset score generation subsystem to create a weight profile associated with multiple maintenance and operational events and timing of the multiple such events of the utility equipment upon determination of a model of the utility equipment from the usage data. The asset score generation subsystem also generates an asset score associated with the model of the utility equipment upon creation of the weight profile based on the multiple parameters. The system also includes an asset score prediction subsystem to predict a rate of variation of the asset score associated with the timing of events of the model of the utility equipment. The system also includes a warranty adjustment subsystem to adjust a warranty period and one or more terms and conditions in a warranty document dynamically based on the rate of variation of the asset score predicted.

In accordance with another embodiment of the present disclosure, a method to provide dynamic warranty for a utility equipment is disclosed. The method includes detecting at least one authenticated component or the at least one authenticated service for uniqueness and compliance by scanning a unique encrypted code associated with the at least one authenticated component or the at least one authenticated service of a utility equipment using one or more detection means. The method also includes identifying usage and event data of the at least one authenticated component or the at least one authenticated service in the utility equipment based on detection of the at least one authenticated component or the at least one authenticated service. The method also includes collecting and storing usage data representative of usage of the at least one authenticated component or the at least one authenticated service via one or more communication platforms for transmission of the usage data to a cloud-based platform. The method also includes creating a weight profile associated with multiple maintenance and operational events and timing of the multiple such events of the utility equipment upon determination of a model of the utility equipment from the usage data. The method also includes generating an asset score associated with the model of the utility equipment upon creation of the weight profile based on multiple parameters. The method also includes predicting a rate of variation of the asset score associated with the timing of events of the model of the utility equipment. The method also includes modifying a warranty period and one or more terms and conditions in a warranty document dynamically based on the rate of variation of the asset score predicted.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 is a block diagram of a system to provide warranty for a utility equipment in accordance with an embodiment of the present disclosure;

FIG. 2 illustrates a schematic representation of an exemplary embodiment of a system to provide warranty for a utility equipment of FIG. 1 in accordance with an embodiment of the present disclosure;

FIG. 3 illustrates a schematic representation of another exemplary embodiment of a system 100 to provide warranty for an industrial utility equipment of FIG. 1 in accordance with an embodiment of the present disclosure;

FIG. 4 illustrates an embodiment representing a system to provide dynamic warranty of new assets and a dynamic warranty of existing assets of FIG. 1 in accordance with an embodiment of the present disclosure;

FIG. 5 is a block diagram of a computer or a server in accordance with an embodiment of the present disclosure; and

FIG. 6 is a flow chart representing the steps involved in a method to provide warranty for a utility equipment in accordance with the embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or sub-systems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

Embodiments of the present disclosure relate to a system and a method to provide warranty for a utility equipment. The system includes a component detection subsystem to detect at least one authenticated component or at least one authenticated service for uniqueness and compliance by scanning a unique encrypted code associated with the at least one authenticated component or the at least one authenticated service of the utility equipment using one or more detection means. The component detection subsystem also identifies usage and event data of the at least one authenticated component or the at least one authenticated service in the utility equipment based on detection of the at least one authenticated component or the at least one authenticated service. The system also includes a usage data collection subsystem to collect usage data representative of usage of the at least one authenticated component or the at least one authenticated service via one or more communication platforms for transmission and storage of the usage data to a cloud-based platform. The system also includes an asset score generation subsystem to create a weight profile associated with multiple maintenance and operational events and timing of the multiple such events of the utility equipment upon determination of a model of the utility equipment from the usage data. The asset score generation subsystem also generates an asset score associated with the model of the utility equipment upon creation of the weight profile based on the multiple parameters. The system also includes an asset score prediction subsystem to predict a rate of variation of the asset score associated with the timing of events of the model of the utility equipment. The system also includes a warranty adjustment subsystem to adjust a warranty period and one or more terms and conditions in a warranty document dynamically based on the rate of variation of the asset score predicted.

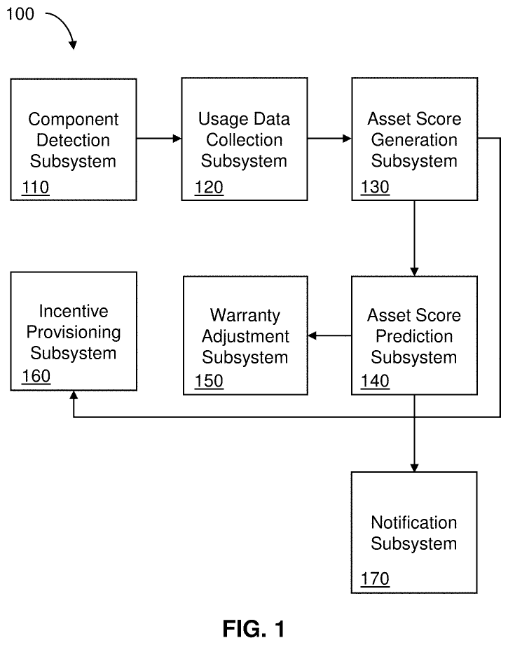

FIG. 1 is a block diagram of a system 100 to provide warranty for a utility equipment in accordance with an embodiment of the present disclosure. In one embodiment, a unique encrypted code is generated and store the encrypted code in a database. In such embodiment, the encrypted code is integrated or embedded with at least one authenticated component or at least one authenticated service of the utility equipment. The system 100 includes a component detection subsystem 110 to detect at least one authenticated component or the at least one authenticated service for uniqueness and compliance by scanning a unique encrypted code associated with the at least one authenticated component or the at least one authenticated service of the utility equipment using one or more detection means.

As used herein, the term ‘unique encrypted code’ is defined as a unique code associated with a component for representation of data in a visual, machine-readable form. In one embodiment, the unique encrypted code may include, but not limited to, a bar code, a quick response (QR) code, an alphanumeric code and the like. In one embodiment, the at least one component may include at least one of a component of an industrial utility equipment, a component of a commercial utility equipment, a component of a consumer utility equipment or a combination thereof. In such embodiment, the at least one authenticated component may include, but not limited to, filters, lubricants, spare parts, engine, compressor, motors, pumps, blades, brakes, battery and the like. In one embodiment, the utility equipment may include, but not limited to, a heavy machine vehicle like trucks, tree-shaker, railway maintenance or construction and material handling portable machines, a consumer electronic product, an portable or stationary industrial machine such as compressors, chillers and the like.

In a specific embodiment, the one or more detection means for the at least one authenticated component or the at least one authenticated service may include a wired detection means. In such embodiment, the wired detection means may include a bar code scanning device. In another embodiment, the one or more wireless detection means for detecting the at least one authenticated component or the at least one authenticated service may include at least one of an application of a computing device for scanning the unique encrypted code, a near-field communication (NFC) tag, a radio-frequency identification (RFID) tag or Bluetooth tag, or a wired sensor or touch technology like electrically erasable programmable read-only memory (EEPROM). The unique encrypted code of the at least one authenticated component or the at least one authenticated service upon scanning is matched with a list of multiple unique encrypted codes associated with multiple authenticated components and multiple authenticated services stored in a component repository and service repository respectively to check the uniqueness of the scanned code. The matching is done to identify usage of the at least one authenticated component or the at least one authenticated service and ensure that the code can be used only once in its lifetime. In one embodiment, the component detection subsystem also identifies usage of the at least one authenticated component or counterfeiting of the at least one authenticated component based on the assets historical data by using the unique encrypted code. In another embodiment, the component detection subsystem also identifies the usage of the at least one authenticated component using one or more artificial intelligence techniques in an absence of unique encrypted code or disconnection of the asset.

The system 100 also includes a usage data collection subsystem 120 to collect usage data representative of usage of the at least one authenticated component or the at least one authenticated service via one or more communication platforms for transmission and storage of the usage data to a cloud-based platform. In one embodiment, the one or more communication platforms may include a gateway or an application platform. In such embodiment, the application platform may include a mobile application. In some embedment, the usage data collection subsystem 120 collects usage data representative of usage of the at least one authenticated component or the at least one authenticated service via the one or more communication platforms for transmission of the usage data to a cloud-based platform in real time. The one or more communication platforms collect the usage data of the at least one authenticated component or the at least one authenticated service by a user and transmits to the cloud-based platform. The cloud-based platform also includes a usage data storage repository which stores the usage data collected via one or more communication platforms. In one embodiment, the usage data may include at least one of data of usage of at least one authenticated component or the at least one authenticated service of the utility equipment in a current time period, data of usage of the at least of the utility equipment in a predefined geographical location, data of installation event, data of maintenance service performed, data of usage of the utility equipment based on guidance provided in a corresponding handbook or a combination thereof.

The system 100 also includes an asset score generation subsystem 130 to create a weight profile associated with the multiple events and timing of the multiple events of the utility equipment upon determination of a model of the utility equipment from the usage data. In one exemplary embodiment, timing of the multiple events may include replacing an air filter in 2 months contains more higher weight than 6 months replacement. In one embodiment, multiple events of the utility equipment may include at least one of a periodic scheduled maintenance event, a repair event, an accident event, an audit event, a financial event, a routine maintenance event or a combination thereof. In such embodiment, the periodic scheduled maintenance event may include at least one of replacing oils, changing filters, recharging batteries, power washing, topping off fluids, rotating tires or a combination thereof. In another embodiment, the repair event may include at least one of installation of new tires or brake pads, replacing failed components, fixing engine transmission or a combination thereof. In yet another embodiment, the accident event may include at least one of earthquake, physical damage, environmental changes or a combination thereof. In one embodiment, the audit event may include at least one of air quality check, energy efficiency check, fluid check or a combination thereof. In another embodiment, the financial event may include at least one of warranty claims, lease expiration or a combination thereof. In yet another embodiment, the routine maintenance event may include at least one of 30-kilometer mile maintenance, 60-kilometer mile maintenance or a combination thereof.

The asset score generation subsystem 130 also generates an asset score associated with the model of the utility equipment upon creation of the weight profile based on multiple parameters. The weight profile is created based on assignment of a weight factor associated with the multiple events corresponding to the model of the utility equipment. The weight factor is determined by an original equipment manufacturer (OEM) based on at least one of historical data corresponding to the multiple events, anecdotal experience corresponding to the multiple events or a combination thereof. The asset score generation subsystem also normalizes the weight factor using one or more normalization techniques for generation of the asset score associated with the model of the utility equipment. In one embodiment, the normalization of the weight factor helps in converting numerical values into a new range by a mathematical function In such embodiment, the one or more normalization techniques may include, but not limited to, SoftMax technique, a min-max normalization technique, Euclidean, a z-score technique, a Box-Cox transformation technique and the like.

In one embodiment, the asset score may include a numerical expression for analyzes of the multiple events of the utility equipment. In such embodiment, the asset score may be generated based on the multiple parameters which may include at least one of performance of the utility equipment such as telemetry of the at least one utility equipment, usage data of the at least one authenticated component, ambient weather such as dusty or clean environment and environmental conditions such as temperature, humidity etc, an operator's handling skill or performance, the plurality of events, timely maintenance of the at least one utility equipment usage of genuine service from authorized certified personnel or a combination thereof. In a specific embodiment, the operator's handling skill may include handling shock, handling vibration, handling improper starting and the like. In some embodiment, the usage data of the at least one authenticated component may include usage of tags to see if the tags are unique, usage of tags to see if the tags are compliant, reminders on lifetime and the like. In such embodiment, the usage of tags to see of the tags are unique may include the tag or filters which cannot be reused again or anyone cannot clean the air filter or refill the ink in the old cartridge. In some embodiment, the usage of tags to see if the tags are compliant may include allowing only premium air filters in premium compressor models. In one embodiment, reminders on lifetime may include generating an alert after expiration of the multiple components such as motors only lasts for 2 years. In one embodiment, the asset score may be generated based on a below defined equation as:

Change in asset score=(W·X)+(Usage since last timestamp*Wu),

wherein the X represents a Boolean vector corresponding to the occurrence of the event, W represents weight vector corresponding to the events and Wu represents weight of usage in asset score.

Further, new normalized asset score=change in asset score+old asset score, wherein the new normalized asset score is updated in database for corresponding time stamp and the asset score.

In one particular embodiment, the asset score generation subsystem 130 generates an asset score for one or more factors associated with the model of the utility equipment, wherein the one or more factors include dynamic calculation of resale value, dynamic dispatch, dynamic parts inventory, dynamic technician pricing, dynamic training, dynamic parts pricing and dynamic repair recommendations. In one embodiment, the customer may visualize the asset score and weight profile of the model of the utility equipment from a digital platform. In such embodiment, the digital platform may include a website published on a web server to depict information about the model of the utility equipment, the asset score, various weight profiles and the like.

In some embodiment, the generated asset score is used to calculate the dynamic resale value using the prior purchase price of the utility equipment, wherein the dynamic resale value is determined by checking the quality of maintenance of the utility equipment. In one exemplary embodiment, the asset score will be better if the one or more genuine parts are used at a right time, which in turn maintains the quality. In another exemplary embodiment, the asset score will be less if the one or more parts used in the utility equipment are not genuine which in turn degrades the quality of maintenance of the utility equipment. Further, the dynamic resale value of the utility equipment may be determined for a second owner and a third owner based on the prior purchase price of the utility equipment.

Furthermore, in one specific embodiment, the asset score is used to determine the age of the utility equipment and provides the data in case of legacy equipment. Based on the determined age and the algorithmic data, a certified technician having the right skills may be dispatched to replace at least one defected part with the at least one authorized part. Further, the asset score is also used to determine the technician's rate dynamically and cost of the overall replacement with guarantee.

In some embodiment, the dynamic technician pricing is calculated by using the asset score, the weight profile and frequency of replacement of parts by the technician. In such embodiment, the asset score, weight profile and the frequency of replacement of parts helps in determining the operator's work to operate the equipment. For example, if the operator has changed the filter 5 times more than needed, then a specific type of training personalized to the customer and the operator may be provided.

In one particular embodiment, the generated asset score may be used to determine the dynamic part inventory and the dynamic part pricing, wherein the dynamic part inventory and the dynamic part pricing is calculated by determining the exact quantity of inventory required by the OEM to keep in hands and the exact quantity of inventory required by the inventory distributor to keep in the warehouse. Further, an understocking and an overstocking of the inventory for OEM and inventory distributors may be removed by determining the exact quantity of the inventory required in both cases. In one embodiment, the asset score is also used to determine which parts are required to ship overnight and which parts are required to keep in stock.

The system 100 also includes an asset score prediction subsystem 140 to predict a rate of variation of the asset score associated with the timing of events of the model of the utility equipment. In one embodiment, the rate of variation of the asset score may be predicted based on the historical asset scores using one or more artificial intelligence-based prediction techniques. In such embodiment, the artificial intelligence-based prediction may include a machine learning technique to predict the rate of variation of the asset score from the new events received in the real time. In a specific embodiment, the system 100 further includes a notification subsystem 170 operatively coupled to the asset score prediction subsystem 140. The notification subsystem 170 sends an alert to the user for notifying a replacement of the at least one authenticated component in the utility equipment based on a pre-defined requirement. In one embodiment, the alert for the replacement may be sent based on a standard lifetime of the at least one authenticated component. In one embodiment, the scheduled maintenance event of the at least one authenticated component may be performed after a pre-defined interval of time. In another embodiment, the conditional maintenance of the at least one authenticated component may depend upon the condition of the at least one authenticated component. In another embodiment, the alert for the replacement of the at least one authenticated component may be sent by the at least one authenticated component itself. In one embodiment, the alert may be sent to the user via one or more communication channels which may include, but not limited to a push notification such as text message, multimedia message, a pop-up notification, an email and the like.

The system 100 also includes a warranty adjustment subsystem 150 to adjust a warranty period and one or more terms and conditions in a warranty document dynamically based on the rate of variation of the asset score predicted. The rate of variation of the asset score includes at least one of an incremental rate or a decremental rate of the asset score. The warranty adjustment subsystem 150 dynamically increases the warranty period based on the incremental rate of the asset score. Similarly, the warranty adjustment subsystem dynamically decreases the warranty period based on the decremental rate of the asset score. In an embodiment, the warranty period may include a duration of warranty document till an expiry date. In such embodiment, the warranty period may include at least one of an hour, a day, a week, a month, a quarter or a combination thereof. In another embodiment, the one or more terms and conditions may include at least one of a warranty type, a warranty scope, a warranty risk, a warranty reward or a combination thereof. In one embodiment, if the dynamic warranty is decreased for a customer, then the one or more terms and conditions such as the warranty type, the warranty length, the warranty scope and the like are decreased based on a consent of the customer. In such a scenario, the customer is offered one or more inducements in higher multiples such as the warranty period increases by two times, the warranty risk, warranty reward and the like.

In one specific embodiment, the notification of adjustment of the dynamic warranty for the model of the utility equipment may be sent via a user login onto the platform, wherein the user may login onto the platform via a monitor. In another embodiment, the user may get notification via a computing device. In such embodiment, the computing device may include a mobile phone, a tablet and the like. In some embodiment, the user may get notification via a computing device through a plurality of communication channels which may include, but not limited to, a short message service (SMS), a multimedia message, a pop-up notification, an email and the like.

In one specific embodiment, the system 100 further includes an incentive provisioning subsystem 160 operatively coupled to the asset score generation subsystem 130. The incentive provisioning subsystem 160 provides one or more dynamic incentives to a user based on the asset score generated. In one embodiment, the one or more dynamic incentives may include at least one of a rebate, a discount, a coupon, a virtual cash, a redeem point, a resale value amount or a combination thereof. In one specific embodiment, the user may get the notification of one or more dynamic incentives via the monitor login or the computing device. In one specific embodiment, the system 100 may include a compliance monitoring subsystem 175 which checks whether the component is supposed to be installed on the utility equipment or not. For example, if “Filter XT” is only recommended for the utility equipment XY, and if installed, then the weight profile and the asset score is higher and if “Filter XS” is installed by mistake, then the weight profile is lower and sends an alert by the notification subsystem 170. However, the utility equipment still operates fine as both filters are still authenticated and genuine parts.

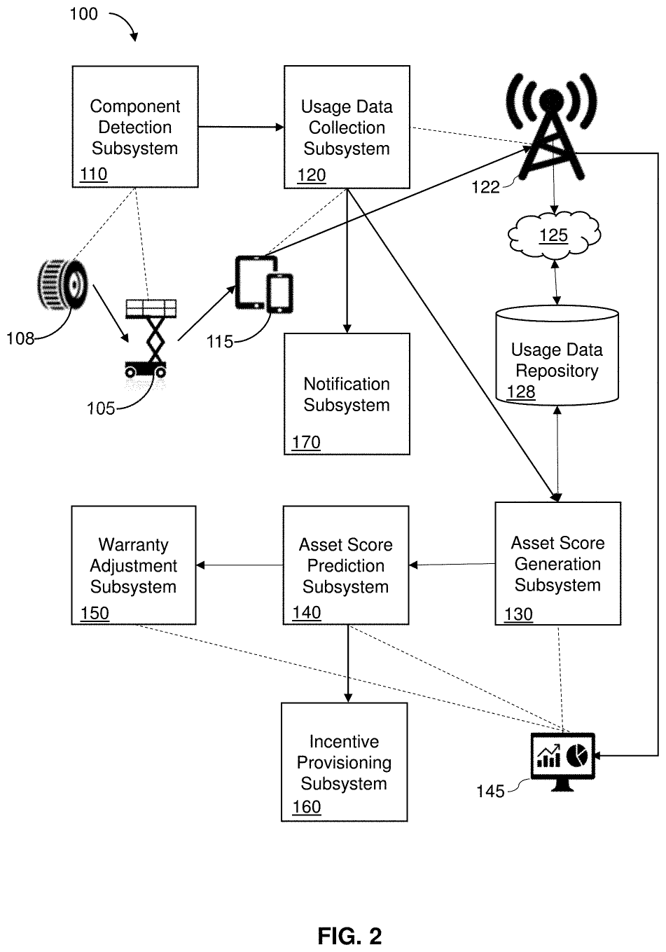

FIG. 2 illustrates a schematic representation of an exemplary embodiment of a system 100 to provide warranty for a utility equipment of FIG. 1 in accordance with an embodiment of the present disclosure. The system 100 provides dynamic warranty to customers who purchase original equipment (OE) and one or more authenticated or genuine components from an original equipment manufacturer (OEM) of any industry. Considering an example, where the OEM ‘A’ manufactures commercial vehicles such as trucks 105. The OEM ‘A’ offers standard fixed-term warranty for new truck sales and such warranties typically last between a definite period of time such as about 3 years. During this warranty period, in case of any damage or replacement, customers are purchasing at least one authenticated component from the OEM. However, during expiration of the warranty period, the customers are avoiding purchase of the at least one authenticated component from the OEM ‘A’ in order to reduce their operational costs. As a result, the OEM ‘A’ is losing after-market sales for the remaining lifetime of the truck sold. In order to manage the after-market sales of the OEM ‘A’, the system 100 is utilized which enables the OEM ‘A’ to offer dynamic warranty programs to the customers.

The system 100 monitors in real-time, the usage of the at least one authenticated component such as a tire 108 of a utility equipment such as the forklift 105. For real-time monitoring, detection of the at least one authenticated component is essential. A component detection subsystem 110 enables detection of the at least one authenticated component for uniqueness by scanning a unique encrypted code associated with the at least one authenticated component of the utility equipment using a wireless detection means such as Bluetooth® tag. In an example used herein, the wireless detection means may include a software application which scans the unique encrypted code associated with the at least one authenticated component. Here, the software application may be via a computing device such as a tablet ‘115’ or mobile phone. Once the code is scanned, the code is matched with a list including multiple codes which is stored in a component data repository in the cloud for uniqueness and compliance. If the scanned code matches with the list of the multiple bar codes for the authenticated equipment, then usage of the at least one authenticated or genuine component is identified by the component detection subsystem 110. The usage identified with the at least one authenticated component helps in understanding warranty status such as either active status or inactive status.

Upon identification of usage, a usage data collection subsystem 120 collects usage data representative of the usage of the at least one authenticated component via a gateway 122 for transmission of the usage data to a cloud-based platform 125. The gateway 122 collects the usage data of the at least one authenticated component from a user and equipment data of equipment in which the component was installed and transmits to the cloud-based platform 125. The cloud-based platform 125 also includes a usage data repository 128 which stores the usage data collected via the gateway 122.

In the cloud-based platform 125, upon transmission of the usage data, multiple details such as a model of the utility equipment, name of the utility equipment, name of an owner of the utility equipment, multiple warranty details including warranty status, warranty type, warranty coverage and the like are fetched. For example, the model of the equipment may include ‘S-45’, the name of the utility equipment as ‘heavy duty truck’ the owner name as ‘X’, the warranty status as ‘active’, the warranty type as ‘standard 3-year warranty’, the warranty coverage as ‘power train and one or more components’. Such information is later utilized by an asset score generation subsystem 130 for creation of a weight profile. The weight profile is created by the asset score generation subsystem 130 in association with multiple events of the utility equipment. For example, the multiple events may include periodic scheduled maintenance, usage of a genuine part, usage of genuine filter, usage of genuine lubricants, installation of new tires 108, air quality check and the like. For each of these multiple events, a corresponding weight factor is assigned for creation of the weight profile. The weight factor is determined by the original equipment manufacturer (OEM) based on at least one of historical data corresponding to the multiple events, anecdotal experience corresponding to the multiple events or a combination thereof. The asset score generation subsystem 130 also normalizes the weight factor using one or more normalization techniques for generation of the asset score associated with the model of the utility equipment. In the example used herein, a min-max normalization technique may be used for normalization of the weight factor.

Once, creation of the weight profile is completed, an asset score associated with the timing of events of the model of the utility equipment is generated via mathematical computation based on multiple parameters. For example, the multiple parameters may include at least one of performance of the utility equipment, usage data of the at least one authenticated component, ambient weather and environmental conditions, an operator's skill or performance, the plurality of events or a combination thereof. The asset score includes a numerical expression for analyzes of the multiple events of the utility equipment. Let's assume, that the asset score for the truck 105 is generated as ‘60’, then such asset score is checked for a predefined interval of time. An asset score prediction subsystem 140, predicts a rate of variation of the asset score associated with the timing of events of the model of the utility equipment. For example, the rate of variation may include an incremental rate or a decremental rate. The asset score prediction subsystem 140 analyzes one or more factors for prediction of the rate of the variation of the asset score. Also, predicted result generated by the asset prediction subsystem is depicted in one or more visualization formats 145 such as charts, graphs and the like for the customer.

Again, a warranty adjustment subsystem 150, adjusts a warranty period and one or more terms and conditions in a warranty document dynamically based on the rate of variation of the asset score predicted. For example, if the rate of variation of the asset score is predicted as increasing, then the warranty adjustment subsystem increases the warranty period. In one non-limiting example, the warranty period, which is extended dynamically, may include an extension of duration of 6 months or 6 days. Also, the one or more terms and conditions in the warranty document increases.

Also, the system 100 includes a notification subsystem 170 which sends an alert to the customer for notifying a replacement of the at least one authenticated component in the utility equipment based on a predefined requirement. For example, the alert for the replacement may be sent based on a standard lifetime of the at least one authenticated component. For example, the alert may be sent to the customer via a text message.

Further, the system 100 also includes an incentive provisioning subsystem 160 which provides one or more dynamic incentives to the customer based on the asset score generated. For example, the one or more dynamic incentives may include at least one of a rebate, a discount, a coupon, a virtual cash, a redeem point, a resale value amount or a combination thereof. Such dynamic incentives motivate the customer or owner of the utility equipment to maintain properly and as a result gets benefitted in terms of receiving dynamic warranty programs as a loyal customer. In addition to, by offering the dynamic warranty programs to the customer, the OEMs also gets benefitted in overcoming the after sales revenue successfully.

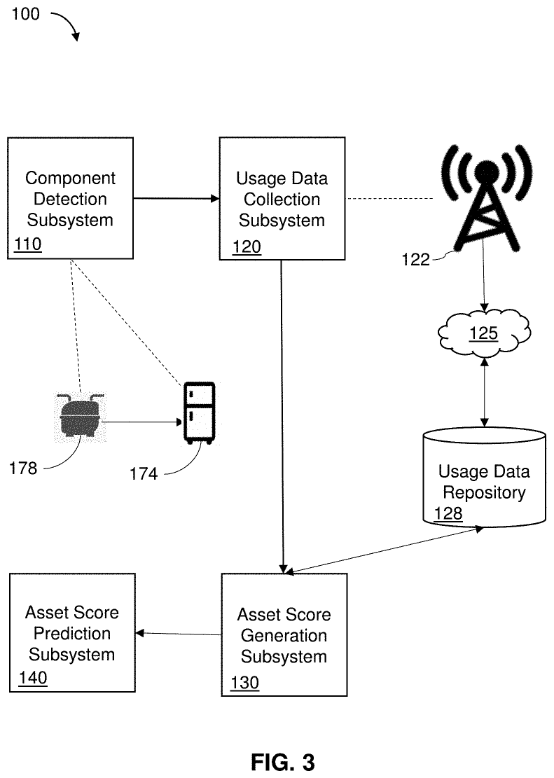

FIG. 3 illustrates a schematic representation of another exemplary embodiment of a system 100 to provide warranty for an industrial utility equipment of FIG. 1 in accordance with an embodiment of the present disclosure. The system 100 provides dynamic warranty to customers who purchase original equipment (OE) and one or more authenticated or genuine components from an original equipment manufacturer (OEM) of any industry. Considering an example, where the OEM ‘A’ manufactures industrial equipment such as refrigerators 174. The OEM ‘A’ offers standard fixed-term warranty for new refrigerator sales and such warranties typically last between a definite period of time such as about 3 years.

The system 100 monitors in real-time, the usage of the at least one authenticated component such as a compressor 178 of the industrial utility equipment such as the refrigerator 174. A component detection subsystem 110 enables detection of the at least one authenticated component for uniqueness by scanning a unique encrypted code associated with the at least one authenticated component of the utility equipment using a wireless detection means such as Bluetooth tag. Upon identification of usage, a usage data collection subsystem 120 collects usage data representative of the usage of the at least one authenticated component via a gateway 122 or mobile phone or tablet 115 for transmission of the usage data to a cloud-based platform 125. The cloud-based platform 125 also includes a usage data repository 128 which stores the usage data collected via the gateway 122 or mobile phone 115.

In the cloud-based platform 125, upon transmission of the usage data, multiple details such as a model of the industrial utility equipment, name of the industrial utility equipment, name of an owner of the industrial utility equipment, multiple warranty details including warranty status, warranty type, warranty coverage and the like are fetched. For example, the model of the industrial utility equipment such as the refrigerator 174 may include ‘L-195’, the owner name as ‘P’, the warranty status as ‘active’, the warranty type as ‘3-year warranty’, the warranty coverage as ‘compressor and one or more components’. Such information is later utilized by an asset score generation subsystem 130 for creation of a weight profile in association with multiple events of the industrial utility equipment. For example, the multiple events may include periodic scheduled maintenance, usage of a genuine part, usage of genuine condenser, installation of new compressor 173, air quality check and the like.

Once, creation of the weight profile is completed, an asset score associated with the timing of events of the model of the utility equipment is generated via mathematical computation based on multiple parameters. Let's assume, that the asset score for the refrigerator 174 is generated as ‘70’, then such asset score is checked for a pre-defined interval of time. An asset score prediction subsystem 140, predicts a rate of variation of the asset score associated with the timing of events of the model of the utility equipment. For example, the rate of variation may include an incremental rate or a decremental rate.

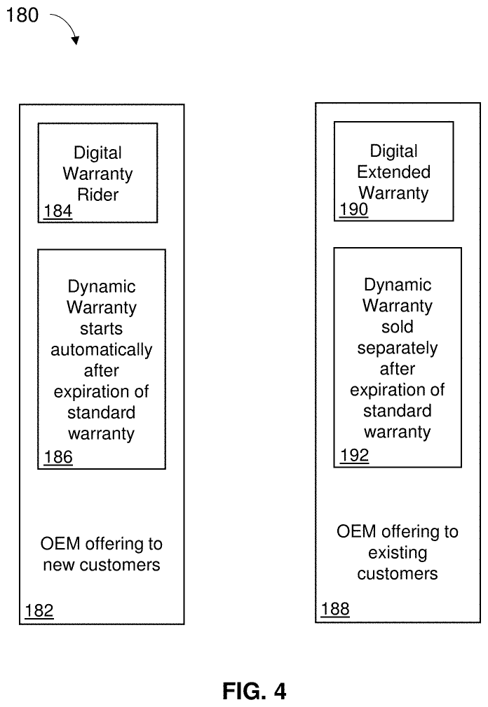

FIG. 4 illustrates an embodiment representing a system 180 to provide dynamic warranty of new assets 182 and a dynamic warranty of existing assets 188 of FIG. 1 in accordance with an embodiment of the present disclosure. The dynamic warranty of new assets is a representative of a digital warranty rider 184 and the dynamic warranty of existing assets is a representative of a digital extended warranty 190. In a case of original equipment manufacturers OEM offering to new customers 182, the dynamic warranty kicks in after the standard warranty is expired 186, where the monitoring of the at least one purchase utility equipment starts from date of purchase. Such dynamic warranty is not a disruptive change, this is a value added on a top of the warranty system. In such case, the warranty claim cost is reduced for the original equipment manufacturers. Also, this will increase the warranty sale due to competitive advantage. Moreover, the parts revenue of the at least one utility equipment gets increased for OEM. In such case, the customers may get a discount based on the asset score. For example, if the asset score is 100%, then the warranty of the at least one purchased utility equipment gets increased by 2×. If the asset score is less than 50%, then the warranty of the at least one purchased utility equipment gets increased by 1.5×. If score is less than 30% then the warranty of the at least one purchased utility equipment gets increased by 1×.

In another case of original equipment manufacturers OEM offering to existing customers 188, extended dynamic warranty is sold separately for additional cost to warranty cliff customers after expiration of the warranty 192. Also, the warranty claim cost is reduced for the original equipment manufacturers. This will increase the warranty sale due to dynamic pricing. Moreover, the OEM recaptures (lost) the parts revenue of the at least one utility equipment. Moreover, the customers may get a discount based on the asset score. For example, if the asset score is 100%, then the customer will get a 30% discount. If the asset score is less than 50%, then the customer will get a 20% discount. If score is less than 30% then the customer will get no discount.

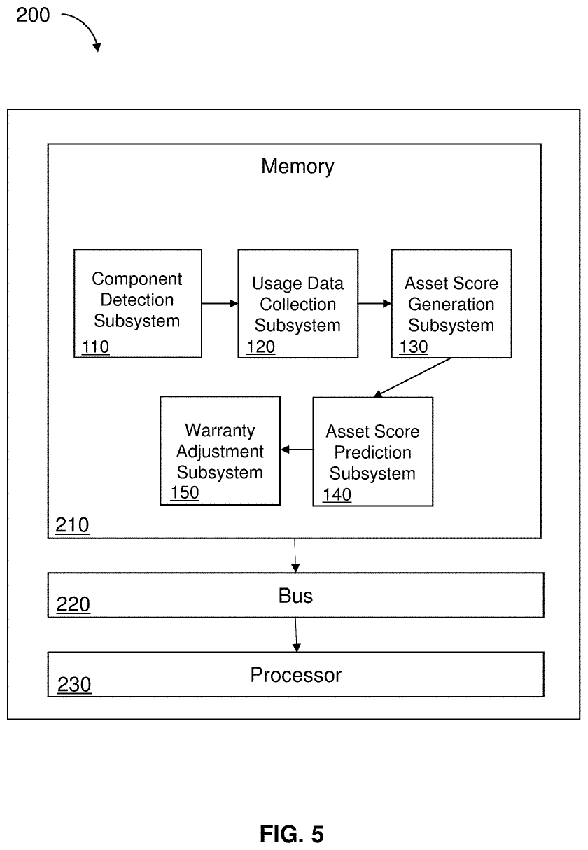

FIG. 5 is a block diagram of a computer or a server in accordance with an embodiment of the present disclosure. The server 200 includes processor(s) 230, and memory 210 operatively coupled to the bus 220. The processor(s) 230, as used herein, means any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a digital signal processor, or any other type of processing circuit, or a combination thereof.

The memory 210 includes several subsystems stored in the form of executable program which instructs the processor 230 to perform the method steps illustrated in FIG. 1. The memory 210 is substantially similar to a system 100 of FIG. 1. The memory 210 has following subsystems: a component detection subsystem 110, a usage data collection subsystem 120, an asset score generation subsystem 130, an asset score prediction subsystem 140 and a warranty adjustment subsystem 150.

The component detection subsystem 110 detects at least one authenticated component or at least one authenticated service for uniqueness and compliance by scanning a unique encrypted code associated with the at least one authenticated component of the utility equipment using one or more detection means. In one embodiment, the component detection subsystem 110 identities usage and event data of the at least one authenticated component or at least one authenticated service or counterfeiting of the at least one authenticated component or at least one authenticated service based on the assets historical data by using the unique encrypted code. In another embodiment, the component detection subsystem 110 also identifies the usage of the at least one authenticated component or the at least one authenticated service using one or more artificial intelligence techniques in an absence of unique encrypted code or disconnection of the asset.

The usage data collection subsystem 120 to collect usage data representative of usage of the at least one authenticated component or the at least one authenticated service via one or more communication platforms for transmission and storage of the usage data to a cloud-based platform. The asset score generation subsystem 130 creates a weight profile associated with multiple maintenance and operational events and timing of the multiple events of the utility equipment upon determination of a model of the utility equipment from the usage data. The asset score generation subsystem 130 also generates an asset score associated with the model of the utility equipment upon creation of the weight profile based on the multiple parameters. The asset score prediction subsystem 140 to predict a rate of variation of the asset score associated with the timing of events of the model of the utility equipment. The warranty adjustment subsystem 150 modifies a warranty period and one or more terms and conditions in a warranty document dynamically based on the rate of variation of the asset score predicted.

The bus 220 as used herein refers to be internal memory channels or computer network that is used to connect computer components and transfer data between them. The bus 220 includes a serial bus or a parallel bus, wherein the serial bus transmits data in bit-serial format and the parallel bus transmits data across multiple wires. The bus 220 as used herein, may include but not limited to, a system bus, an internal bus, an external bus, an expansion bus, a frontside bus, a backside bus and the like

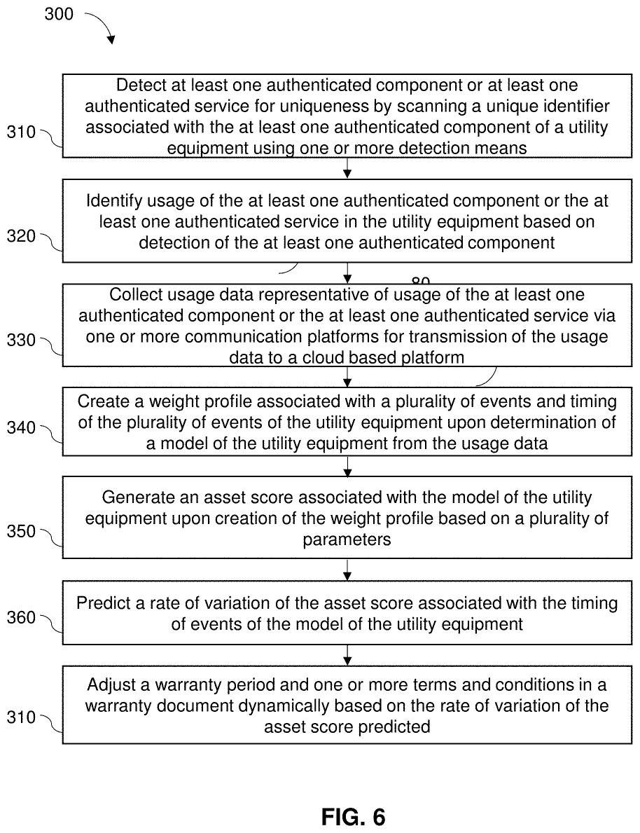

FIG. 6 is a flow chart representing the steps involved in a method 300 to provide warranty for a utility equipment in accordance with the embodiment of the present disclosure. In one embodiment, the method 300 may include generating a unique encrypted code is generated and store the encrypted code in a database. In such embodiment, the method 300 may include integrating or embedding the encrypted code with at least one authenticated component or at least one authenticated service of the utility equipment. The method 300 includes detecting at least one authenticated component or the at least one authenticated service for uniqueness by scanning a unique encrypted code associated with the at least one authenticated component or the at least one authenticated service of a utility equipment using one or more detection means in step 310. In one embodiment, detecting the at least one authenticated component or the at least one authenticated service for uniqueness may include detecting the at least one authenticated component or the at least one authenticated service by scanning the unique encrypted code which may include but not limited to, a bar code, a quick response (QR) code, an alphanumeric code and the like. In such embodiment, detecting the at least one authenticated component or the at least one authenticated service for the uniqueness may include detecting the at least one authenticated component or the at least one authenticated service using a wired detection means. In such embodiment, the wired detection means may include a bar code scanning device. In another embodiment, detecting the unique encrypted code using the one or more detection means may include detecting the unique encrypted code using a wireless detection means which may include at least one of an application of a computing device for scanning the unique encrypted code, a near-field communication (NFC) tag, a radio-frequency identification (RFID) tag or Bluetooth® tag, or a wired sensor or touch technology like electrically erasable programmable read-only memory (EEPROM).

The method 300 also includes identifying usage of the at least one authenticated component or the at least one authenticated service or counterfeiting of the at least one authenticated component or the at least one authenticated service based on the detection of the at least one authenticated component or the at least one authenticated service in step 320, wherein the detection of the at least one authenticated component or the at least one authenticated service may be done by scanning the unique encrypted code. In one embodiment, identifying the usage of the at least one authenticated component or the at least one authenticated service may include identifying the usage by matching the unique encrypted code of the at least one component or the at least one authenticated service upon scanning with a list of multiple unique encrypted codes associated with multiple authenticated components and multiple authenticated services stored in a component repository and a service repository respectively. In another embodiment, the method 300 may include identifying the usage of the at least one authenticated component or the at least one authenticated service using one or more artificial intelligence techniques in an absence of unique encrypted code or disconnection of the asset.

The method 300 also includes collecting usage data representative of usage of the at least one authenticated component or the at least one authenticated service via one or more communication platforms for transmission of the usage data to a cloud-based platform in step 330. In one embodiment, collecting the usage data representative of the usage of the at least one authenticated equipment may include collecting the usage data which may include at least one of data of usage of at least one authenticated component or the at least one authenticated service of the utility equipment in a current time period, data of usage of the at least of the utility equipment in a predefined geographical location, data of usage of the utility equipment based on guidance provided in a corresponding handbook or a combination thereof.

The method 300 also includes creating a weight profile associated with multiple events and timing of the multiple events of the utility equipment upon determination of a model of the utility equipment from the usage data in step 340. In one embodiment, creating the weight profile associated with the multiple events and timing of the multiple events of the utility equipment may include creating the weight profile associated with at least one of a periodic scheduled maintenance event, a repair event, an accident event, an audit event, a financial event, a routine maintenance event or a combination thereof. In such embodiment, creating weight profile associated with the periodic scheduled maintenance event may include creating the weight profile associated with at least one of replacing oils, changing filters, topping off fluids, recharging batteries, rotating tires or a combination thereof. In another embodiment, the repair event may include at least one of installation of new tires or brake pads, replacing failed parts, fixing engine transmission or a combination thereof. In yet another embodiment, the accident event may include at least one of earthquake, physical damage, environmental changes or a combination thereof. In one embodiment, the audit event may include at least one of air quality check, energy efficiency check, fluid check or a combination thereof. In another embodiment, the financial event may include at least one of warranty claims, lease expiration or a combination thereof. In yet another embodiment, the routine maintenance event may include at least one of 30-kilometer mile maintenance, 60-kilometer mile maintenance or a combination thereof.

The method 300 also includes generating an asset score associated with the model of the utility equipment upon creation of the weight profile based on multiple parameters in step 350. In one embodiment, generating the asset score associated with the model of the utility equipment may include generating the asset score based on at least one of performance of the utility equipment such as telemetry of the at least one utility equipment, usage data of the at least one authenticated component, ambient weather such as dusty or clean environment and environmental conditions such as temperature, humidity etc, an operator's handling skill or performance, the plurality of events, timely maintenance of the at least one utility equipment usage of genuine service from authorized certified personnel or a combination thereof. In an embodiment, creation of the weight profile may include creation of the weight profile by assignment of a weight factor associated with the multiple events corresponding to the model of the utility equipment. The weight factor is determined by an original equipment manufacturer (OEM) based on at least one of historical data corresponding to the multiple events, anecdotal experience corresponding to the multiple events or a combination thereof. The asset score generation subsystem also normalizes the weight factor using one or more normalization techniques for generation of the asset score associated with the model of the utility equipment.

The method 300 also includes predicting a rate of variation of the asset score associated with the timing of events of the model of the utility equipment in step 360. In one embodiment, predicting the rate of variation of the asset score associated with the timing of events of the model of the utility equipment may include predicting the rate of variation of the asset score using one or more artificial intelligence-based prediction techniques. In a particular embodiment, the method 300 further includes sending, by a notification system, an alert to the user for notifying a replacement of the at least one authenticated component in the utility equipment based on a predefined requirement. In one embodiment, the alert for the replacement may be sent based on a standard lifetime of the at least one authenticated component. In another embodiment, the alert for the replacement of the at least one authenticated component may be sent by the at least one authenticated component itself. In sending the alert to the user may include sending the alert via one or more communication channels which may include, but not limited to a push notification such as text message, multimedia message, a pop-up notification, an email and the like.

The method 300 also includes modifying a warranty period and one or more terms and conditions in a warranty document dynamically based on the rate of variation of the asset score predicted instep 370. In one embodiment, modifying the warranty period dynamically may include increasing the warranty period based on an incremental rate of the variation of the asset score. In another embodiment, modifying the warranty period dynamically may include decreasing the warranty period based on a decremental rate of the variation of the asset score. In one embodiment, the modifying the warranty period may include modifying a duration of warranty document till an expiry date. In such embodiment, the warranty period may include at least one of an hour, a day, a week, a month, a quarter or a combination thereof. In one embodiment, modifying the one or more terms and conditions in the warranty document may include modifying at least one of a warranty type, a warranty scope, a warranty risk, a warranty reward or a combination thereof. In one specific embodiment, the method 300 may include checking, by a compliance monitoring subsystem, whether the component is supposed to be installed on the utility equipment or not. For example, if “Filter XT” is only recommended for the utility equipment XY, and if installed, then weight profile and asset score is higher and if “Filter XS” is installed by mistake, then the weight profile is lower and sends an alert by the notification subsystem.

In a specific embodiment, the method 300 further includes providing, by an incentive provisioning subsystem, one or more dynamic incentives to a user based on the asset score generated. In one embodiment, the one or more dynamic incentives may include at least one of a rebate, a discount, a coupon, a virtual cash, a redeem point, a resale value amount or a combination thereof.

From the technical effect point of view, the present system reduces an expenditure on hardware side as the system is developed on a cloud server. Also, the present disclosure increases the processing speed as the processors used in the system are hosted on the cloud server.

Various embodiments of the present disclosure relate to a system for providing dynamic warranty program to a customer by increasing and decreasing the warranty term and/or features in small increments based on usage of authenticated components by customers which not only motivates the user to handle the equipment properly but also benefits the OEMs in receiving the after sales revenue. Moreover, the present disclosed system offers the dynamic warranty program based on detection of the at least one authenticated component which helps in identifying the uniqueness of the authorised equipment and also usage of the at least one authenticated component in the utility equipment accurately.

Furthermore, the present disclosed system utilizes artificial intelligence-based technologies to generate the asset score which determines an equipment's events at a given time and enables the OEMs or owners to quickly determine the current state of the machine and compare it with similar machines easily and effectively.

It will be understood by those skilled in the art that the foregoing general description and the following detailed description are exemplary and explanatory of the disclosure and are not intended to be restrictive thereof.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, the order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

We claim:

1. A system to provide warranty for a utility equipment, the system comprising:
one or more processors hosted on a server;
a component detection subsystem configured to:
detect at least one authenticated component or at least one authenticated service for uniqueness and compliance by scanning a unique encrypted code associated with the at least one authenticated component or the at least one authenticated service of the utility equipment using one or more detection means; and
identify usage and event data of the at least one authenticated component or the at least one authenticated service in the utility equipment based on detection of the at least one authenticated component or the at least one authenticated service;
a usage data collection subsystem operatively coupled to the component detection subsystem, wherein the usage data collection subsystem is configured to collect usage data representative of usage of the at least one authenticated component or the at least one authenticated service via one or more communication platforms for transmission and storage of the usage data to a cloud based platform;
an asset score generation subsystem operatively coupled to the usage data collection subsystem, wherein the asset score generation subsystem is configured to:
create a weight profile associated with a plurality of maintenance and operational events and timing of the plurality of events of the utility equipment upon determination of a model of the utility equipment from the usage data; and
generate an asset score associated with the model of the utility equipment upon creation of the weight profile based on a plurality of parameters;
an asset score prediction subsystem operatively coupled to the asset score generation subsystem, wherein the asset score prediction subsystem is configured to predict a rate of variation of the asset score associated with the timing of events of the model of the utility equipment; and
a warranty adjustment subsystem operatively coupled to the asset score prediction subsystem, wherein the warranty adjustment subsystem is configured to adjust a warranty period and one or more terms and conditions in a warranty document dynamically based on the rate of variation of the asset score predicted.

2. The system of claim 1, wherein the server comprises a remote server.

3. The system of claim 1, wherein the at least one authenticated component comprises at least one of a component of an industrial utility equipment, a component of a commercial utility equipment, a component of a consumer utility equipment or a combination thereof.

4. The system of claim 1, wherein the one or more detection means comprises a wired detection means.

5. The system of claim 1, wherein the one or more detection means comprises a wireless detection means.

6. The system of claim 1, wherein the plurality of events comprises at least one of a periodic scheduled maintenance event, a repair event, an accident event, an audit event, a financial event, a routine maintenance event or a combination thereof.

7. The system of claim 1, wherein the weight profile is created based on assignment of a weight factor associated with the plurality of events corresponding to the model of the utility equipment.

8. The system of claim 7, wherein the weight factor is determined by an original equipment manufacturer based on at least one of historical data corresponding to the plurality of events, anecdotal experience corresponding to the plurality of events or a combination thereof.

9. The system of claim 1, wherein the asset score generation subsystem is configured to normalize a weight factor using one or more normalization techniques for generation of the asset score associated with the model of the utility equipment.

10. The system of claim 1, wherein the plurality of parameters comprise at least one of performance of the utility equipment, wherein the at least one of performance of the utility equipment comprises telemetry of the at least one utility equipment, usage data of the at least one authenticated component, ambient weather and environmental conditions, an operator's handling skill or performance, the plurality of events, timely maintenance of the at least one utility equipment usage of genuine service from authorized certified personnel or a combination thereof.

11. The system of claim 1, wherein the asset score comprises a numerical expression for analyzes of the plurality of events of the utility equipment.

12. A method for providing warranty for a utility equipment, the method comprising:
detecting, by a component detection subsystem, at least one authenticated component or at least one authenticated service for uniqueness and compliance by scanning a unique encrypted code associated with the at least one authenticated component by scanning a unique encrypted code associated with the at least one authenticated component or the at least one authenticated service of a utility equipment using one or more detection means;
identifying, by the component detection subsystem, usage and event data of the at least one authenticated component or the at least one authenticated service in the utility equipment based on detection of the at least one authenticated component or the at least one authenticated service;
collecting, by a usage data collection subsystem, usage data representative of usage of the at least one authenticated component or the at least one authenticated service via one or more communication platforms for transmission and storage of the usage data to a cloud based platform;
creating, by an asset score generation subsystem, a weight profile associated with a plurality of maintenance and operational events and timing of the plurality of events of the utility equipment upon determination of a model of the utility equipment from the usage data:
generating, by the asset score generation subsystem, an asset score associated with the model of the utility equipment upon creation of the weight profile based on a plurality of parameters;
predicting by an asset score prediction subsystem, a rate of variation of the asset score associated with the timing of events of the model of the utility equipment; and
adjusting, by a warranty adjustment subsystem, a warranty period and one or more terms and conditions in a warranty document dynamically based on the rate of variation of the asset score predicted.

13. The method of claim 12, comprising generating, by the asset score generation subsystem, an asset score for one or more factors associated with the model of the utility equipment, wherein the one or more factors comprise dynamic calculation of resale value, dynamic dispatch, dynamic parts inventory, dynamic technician pricing, dynamic training, dynamic parts pricing and dynamic repair recommendations.

14. The method of claim 12, wherein adjusting the warranty period comprises dynamically increasing the warranty period based on an incremental rate of the asset score.

15. The method of claim 12, wherein adjusting the warranty period comprises dynamically decreasing the warranty period based on a decremental rate of the asset score.

16. The method of claim 12, wherein adjusting the warranty period comprises adjusting a duration of the warranty document till an expiry date.

17. The method of claim 12, wherein adjusting the one or more terms and conditions comprise adjusting at least one of a warranty type, a warranty scope, a warranty risk, a warranty reward or a combination thereof.

18. The method of claim 12, comprising providing, by an inventive provisioning subsystem, one or more dynamic incentives to a user based on the asset score generated.

19. The method of claim 18, wherein providing the one or more dynamic incentives comprises providing at least one of a rebate, a discount, a coupon, a virtual cash, a redeem point, a resale value amount or a combination thereof.

20. The method of claim 12, comprising sending, by a notification subsystem, an alert to the user for notifying a replacement of the at least one authenticated component in the utility equipment based on a predefined requirement.
